(19) United States
(12) Patent Application Publication
(10) Pub. No.: US 2016/0290627 A1
(43) Pub. Date: Oct. 6, 2016

(54) EMERGENCY LOCATOR BEACON

(71) Applicants: Kevin Romney Payne, Spanish Fork, UT (US); Danyelle Payne, Spanish Fork, UT (US)

(72) Inventors: Kevin Romney Payne, Spanish Fork, UT (US); Danyelle Payne, Spanish Fork, UT (US)

(21) Appl. No.: 15/092,509

(22) Filed: Apr. 6, 2016

Related U.S. Application Data
(60) Provisional application No. 62/143,270, filed on Apr. 6, 2015.
(60) Provisional application No. 62/202,053, filed on Aug. 6, 2015.

(51) Int. Cl. F21V 33/00; F21V 23/04; F21L 4/00

(52) U.S. Cl. CPC F21V 33/0076; F21L 4/005; F21V 23/0414; F21W 2111/10

(57) ABSTRACT

An emergency locator beacon is provided. The emergency locator beacon may include a deployable helium balloon and a helium cylinder and a manually pumped air horn enclosed as part of a flashlight. The emergency locator beacon is compact and can be carried by outdoor enthusiasts in many situations without inconvenience to provide multiple ways to signal a need for assistance if the person becomes lost or incapacitated.

### RELATED APPLICATIONS

The present application claims the benefit of U.S. Provisional Application Ser. No. 62/143,270, filed Apr. 6, 2015, which is herein incorporated by reference in its entirety, and also claims the benefit of U.S. Provisional Application Ser. No. 62/202,053, filed Aug. 6, 2015, which is herein incorporated by reference in its entirety.

### THE FIELD OF THE INVENTION

The present invention relates to an emergency beacon. In particular, examples of the present invention relates to a portable emergency beacon which may be carried and deployed to assist in locating and rescuing a person who is lost or otherwise in need of assistance.

### BACKGROUND

Outdoor recreation such as hiking, backpacking, etc. has become increasingly popular. To date, however, there is a need for increased safety for persons engaged in outdoor recreation. When a person is camping, hiking, etc. they will typically have no access to cellular networks to use a mobile telephone and have limited ability to determine where they are or to contact others to obtain assistance. Injured persons may not be able to move any significant distance and may have little ability to contact other persons for assistance. In many situations, it is desirable for a lost or injured person to remain in their location and allow others to come to them. There is thus a need for a person who needs assistance to quickly and reliably communicate their location and their need of assistance to others.

### BRIEF DESCRIPTION OF THE DRAWINGS

Non-limiting and non-exhaustive examples of the present invention are described with reference to the following figures, wherein like reference numerals refer to like parts throughout the various views unless otherwise specified.

FIG. 1 is a drawing which shows a perspective view of an emergency locator beacon.

FIGS. 2 and 3 are drawings which show partially transparent views of components of the beacon.

FIG. 4 is a drawing which shows an exploded view of components of the beacon.

FIG. 5 is a drawing showing a perspective view of components of the beacon.

FIGS. 6 and 7 are partial cross sectional views of components of the beacon.

FIG. 8 is a drawing showing a perspective view of components of the beacon.

FIGS. 9 and 10 are partial cross sectional views of components of the beacon.

FIG. 11 is a schematic drawing of the deployed beacon.

FIG. 12 is a drawing which shows a perspective view of an emergency locator beacon.

Corresponding reference characters indicate corresponding components throughout the several views of the drawings. Skilled artisans will appreciate that elements in the figures are illustrated for simplicity and clarity. The drawings have been drawn to scale to allow for understanding of the device. Common but well-understood elements that are useful or necessary in a commercially feasible embodiment are often not depicted in order to facilitate a less obstructed view of these various embodiments of the present invention.

It will be appreciated that the drawings are illustrative and not limiting of the scope of the invention which is defined by the appended claims. The examples shown each accomplish various different advantages. It is appreciated that it is not possible to clearly show each element or advantage in a single figure, and as such, multiple figures are presented to separately illustrate the various details of the examples in greater clarity. Similarly, not every example need accomplish all advantages of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the features, structures or characteristics may be combined in any suitable combinations and/or sub-combinations in one or more embodiments or examples. In addition, it is appreciated that the figures provided herewith are for explanation purposes to persons ordinarily skilled in the art.

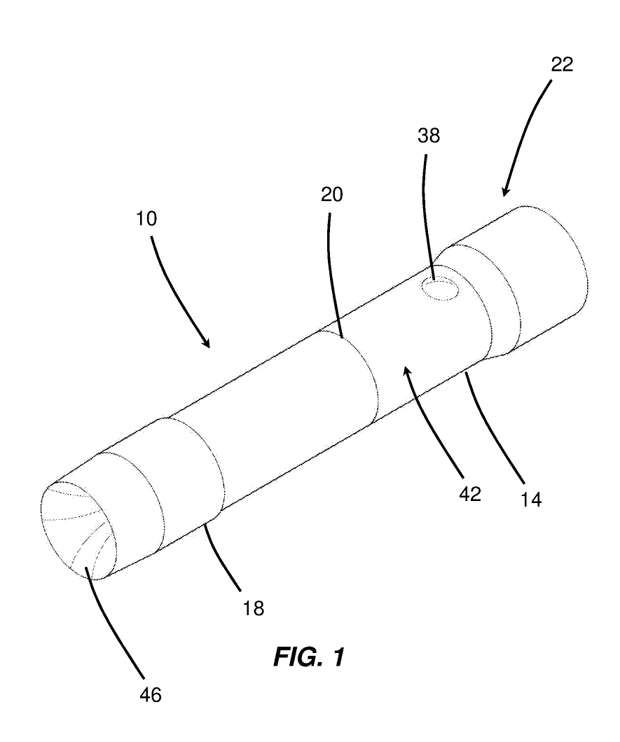

Referring now to FIG. 1, a perspective view of an emergency locator beacon is shown. The example emergency locator beacon 10 is designed for use by persons who are in need of assistance such as medical assistance or assistance being located and recovered from outdoor locations. The emergency locator beacon 10 is useful for persons who are camping, hiking, biking, off-highway vehicle riding, etc. The emergency locator beacon has been designed to provide multiple ways in which a person who is in need of assistance can present their location to others and maximize the likelihood that they are located and assisted by other people while maintaining a small form factor and low weight which do not interfere with many modes of outdoor recreation. Because of this, a person may carry the emergency locator beacon with them while they are engaged in many forms of outdoor recreation so that they may be more easily rescued if they become lost, injured, or otherwise in need of assistance.

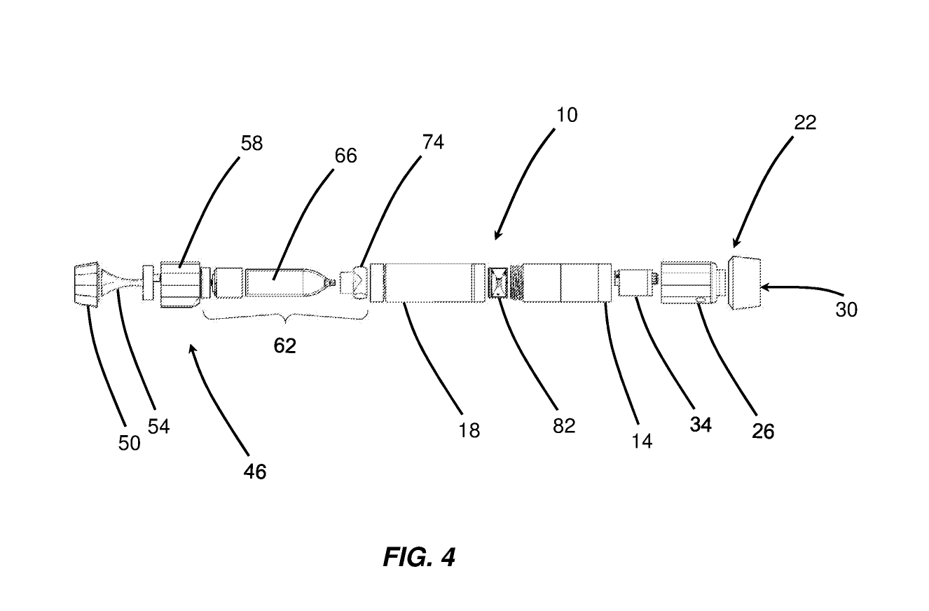

The emergency locator beacon 10 includes a first end 14 and a second end 18. The first end 14 and second end 18 may be separated from each other at a joint 20 which attaches the first and seconds end together during use of the emergency locator beacon 10. The first end 14 includes a flashlight 22 which may include a flashlight housing 26 (see FIG. 4), a lens and LED light source 30, a battery 34, and a switch 38. The flashlight 22 may be used as a conventional flashlight as well as an emergency beacon. For use as an emergency beacon, it is often desirable that the flashlight 22 is constructed with narrow beam LEDs to maximize the visibility of the light at larger distances. The first end 14 may also include an internal storage cavity 42.

The second end 18 of the emergency locator beacon 10 includes a manually pumped air horn 46. The air horn 46 may include an external cap 50, a trumpet 54 (i.e. a horn; horn body), a housing 58, and a manual piston pump 70 including a pump piston 62. The air horn housing 58 may form an end of the cylinder in which the pump piston 62 moves and may also form a fluid passage between the cylinder and the horn trumpet 54. The pump piston 62 is formed by a helium cylinder 66. In one example, a 95 cc helium cylinder is used. The pump piston 62 is manually pumped in and out of a cylinder to pump air through the air horn trumpet 54 and create a loud and distinctive sound which may be used to signal that a person is in need of assistance.

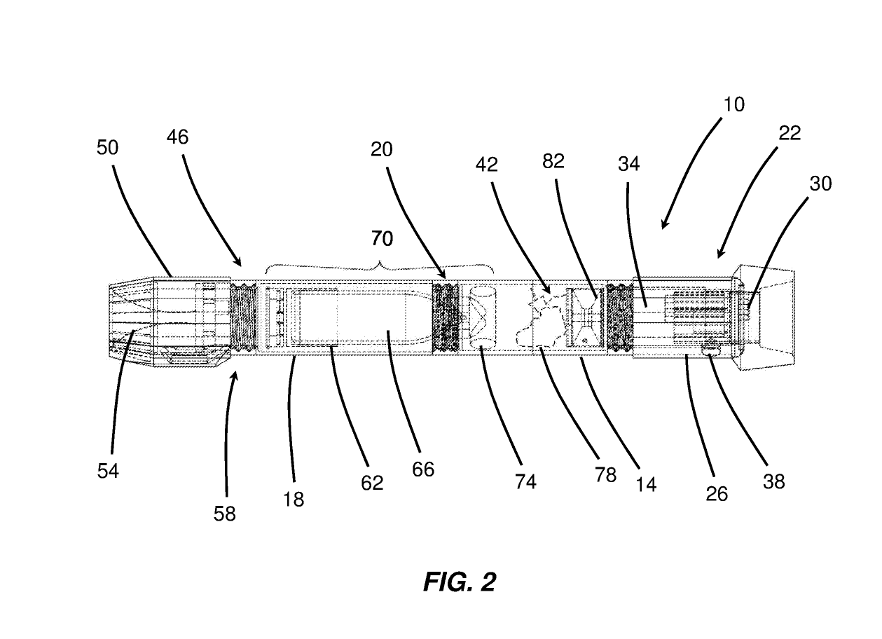

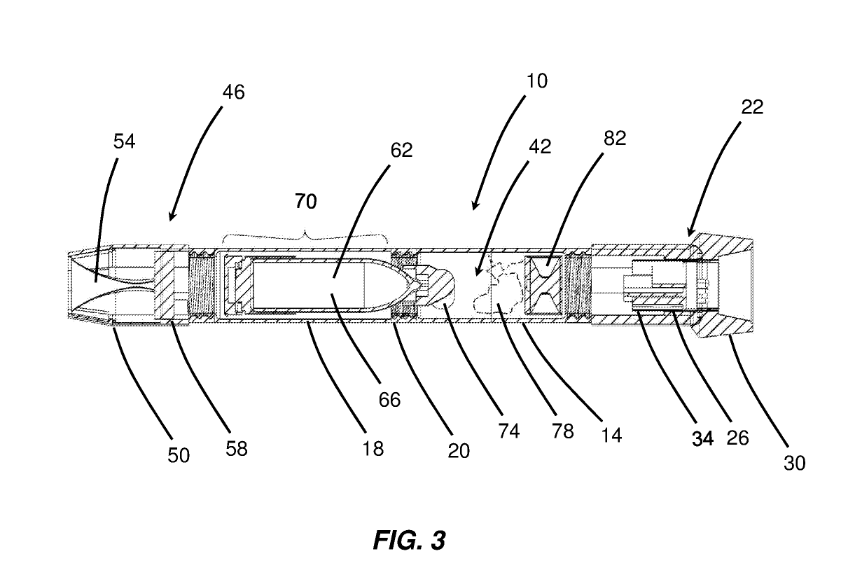

Referring now to FIGS. 2 and 3, partially cut away and partially transparent views of the emergency locator beacon 10 are shown. FIG. 3 particularly shows the various components of the emergency locator beacon 10. The first end 14 and second end 18 of the body of the emergency locator beacon 10 may be formed from aluminum tube or other suitable materials. As discussed, the aluminum tube body 18 of the second end of the emergency locator beacon may form the cylinder of the manual air pump 70 used to pump air to the air horn 46. The second end of the body 18 may be formed with a smooth internal wall and, combined with a bulkhead such as the air horn housing 58, form the pump cylinder. The second end 18 of the emergency locator beacon body is formed such that when the pump piston 62 is pushed fully into the cylinder opening, a handle 74 protrudes from the second end 18 of the emergency locator beacon body. The cylinder and piston 62 may provide approximately 2 or 3 inches of stroke in a 1.5 inch bore and may pump between about 3 and 6 cubic inches of air per stroke at a relatively high pressure and velocity to power the air horn. Since it is manually powered, the air horn may provide a person with a continuously operable beacon to convey their location to others which does not depend on a battery source, etc.

The first end 14 of the emergency locator beacon body may also be formed from aluminum tube and the flashlight 22 may be removably attached to an end of this tube. As discussed, the first end 14 of the emergency locator beacon body forms a storage chamber 42.

When the first half 14 and the second half 18 of the emergency locator beacon 10 are connected together, the handle 74 of the pump piston 62 extends into the storage chamber 42. The storage chamber also houses emergency items including a balloon 78 and a spool 82. These items, as well as the manual air pump 70, are accessed when the first end 14 and second end 18 of the emergency locator beacon 10 are separated from each other. FIG. 4 shows an exploded view of various components of the emergency locator beacon 10.

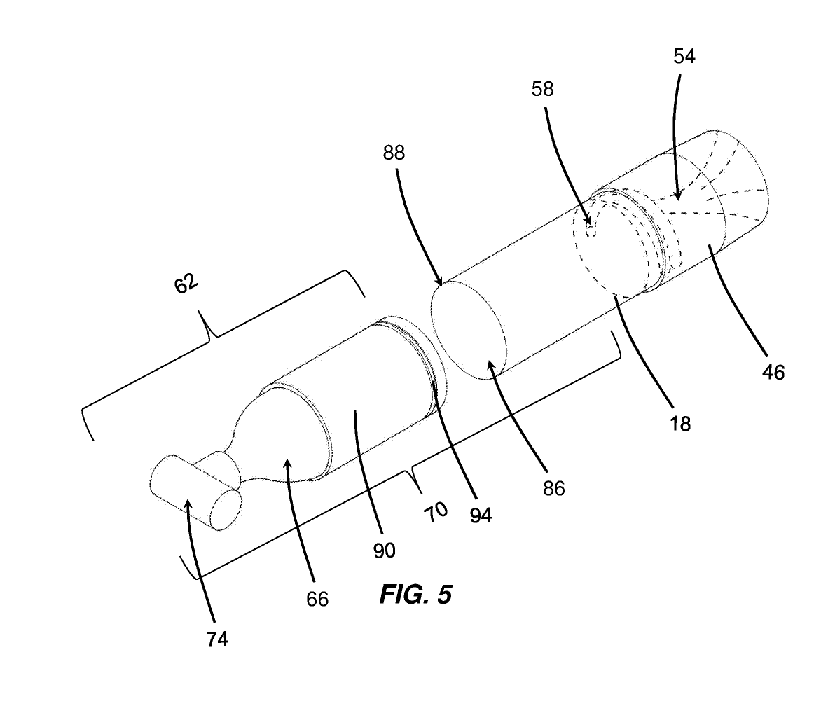

Referring now to FIG. 5, a perspective view of the second end 18 of the emergency locator beacon 10 is shown. The second end 18 of the body; e.g. an aluminum tube forming the second end 18 of the emergency locator beacon body, and a bulkhead or a portion of the air horn housing 58 form a cylinder 86 between an open end 88 of the second end 18 and the air horn housing 58. The cylinder 86 receives the pump piston 62 and forms a manually powered pump 70 which pumps air through the air horn trumpet 54.

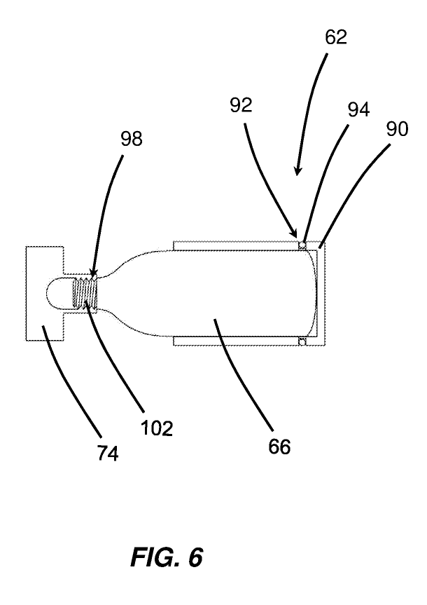

FIG. 6 shows a partial cross sectional view of the piston pump 62. The pump 62 is formed by a helium cylinder 66. A shell 90 is attached to the body of the helium cylinder 66. The shell 90 may be bonded to the helium cylinder with an adhesive. The shell 90 provides a groove 92 which holds a rubber O-ring 94 to improve the seal between the piston 62 and the cylinder 86. A handle 74 is attached to the helium cylinder. The handle 74 includes an internal thread 98 which is attached to the threaded end 102 of the helium cylinder 66. The helium cylinder 66 is sealed until use with a locator balloon 78 and may still be used as a pump piston to power the air horn 54 after deploying the helium filled locator balloon.

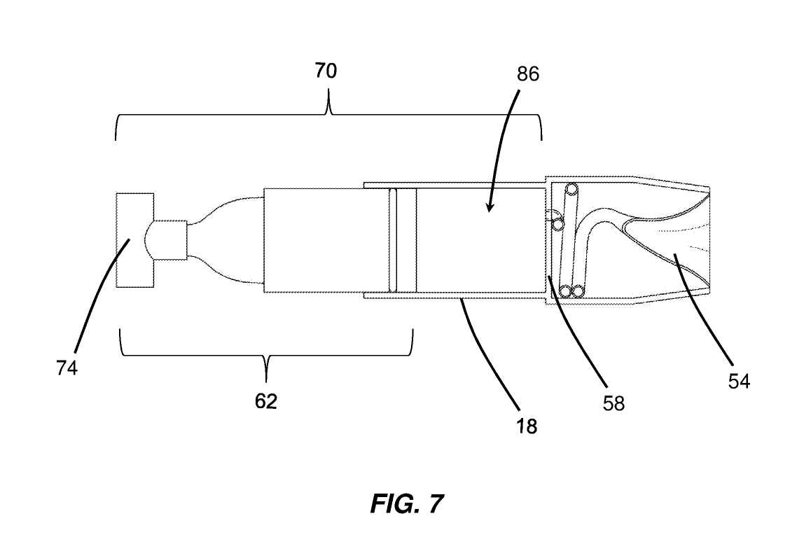

FIG. 7 shows an assembled view of the pump 70. The handle 74 is used by a person to quickly push/pull the piston 62 into and out of the cylinder 86 to pump air through the air horn trumpet 54. The bulkhead 58 or a portion of the cylinder wall may include a check valve to allow a person to more easily use the air horn. The check valve may allow ingress of air while a person is retracting the pump piston 62 and seal while the person is pushing the piston inwardly to force air through the horn 54.

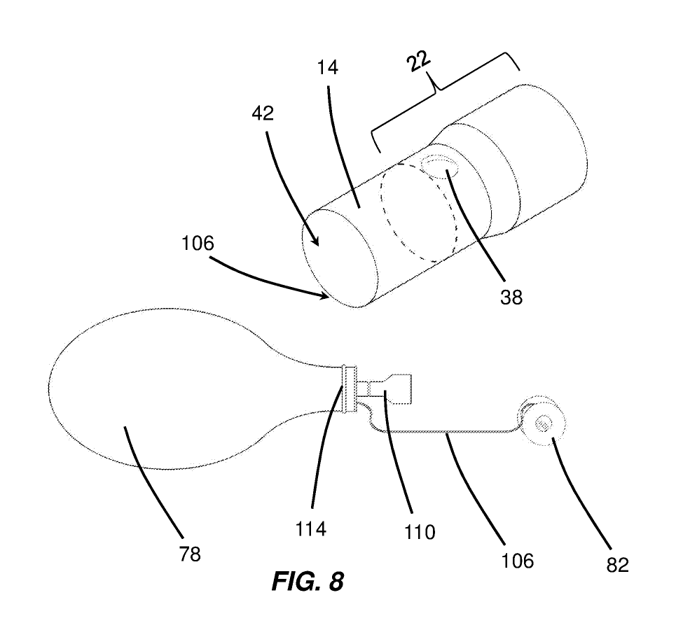

Referring now to FIG. 8, a perspective view of the first end 14 of the emergency locator beacon 10 is shown. As discussed, the first end 14 of the emergency locator beacon body may be formed from aluminum tube and may have an open end 106 and may form a cavity 42 between the open end 106 and the flashlight 22. The cavity 42 may be used to store a balloon 78 and a spool 82 of monofilament or similar line 106 which is connected to the balloon 78. A filler valve 110 is attached to the neck of the balloon 78 with a ring clamp 114 such as an elastic O-ring. The filler valve 110 is inserted into the neck of the balloon 78 so that the balloon neck is stretched slightly around the filler valve 110 and the clamp 114 holds the balloon neck against the filler valve. The clamp 114 may be an elastic band such as an O-ring, heat shrink tubing, etc. An adhesive or sealant may be used between the balloon neck and filler valve 110 if desired.

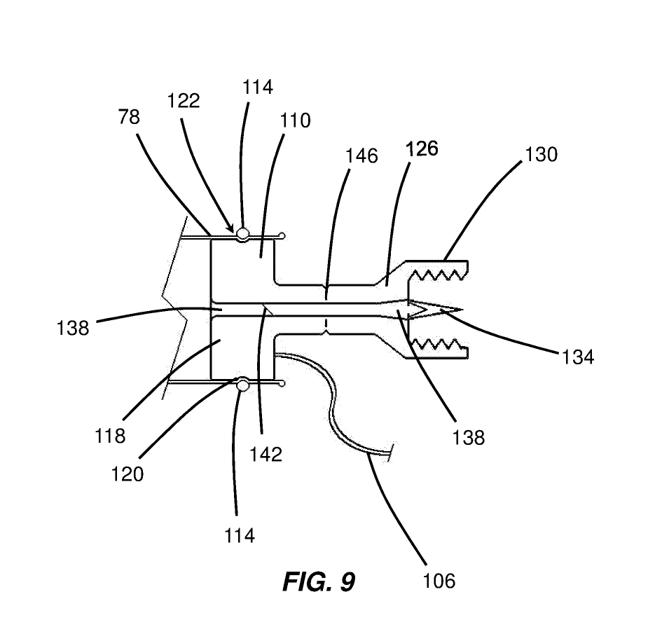

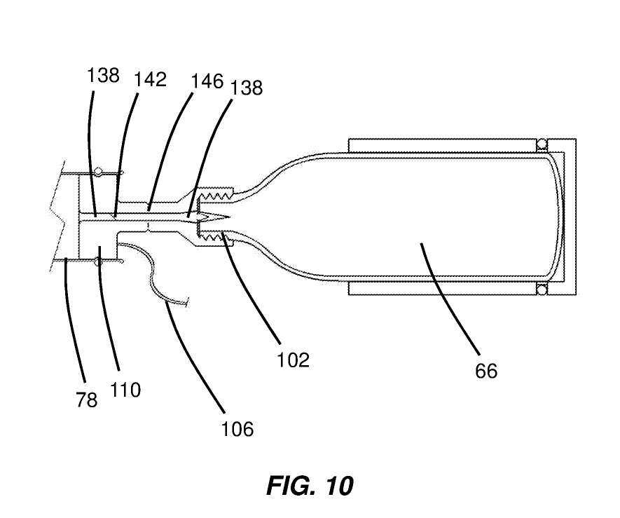

FIG. 9 shows a cross sectional view of the filler valve 110. The filler valve 110 includes a body 118 which fits within the balloon neck. The body 118 is often slightly larger in diameter than the inside diameter of the balloon neck so that it is a tight fit in the balloon neck to improve sealing with the balloon neck. A circumferential groove 122 may be formed around the body 118 which receives the clamp 114. In one example, the minor, reduced diameter of the circumferential groove 122 may be larger in diameter than the inside diameter of the balloon neck. The filler valve includes a stem 126 and threaded cap 130. The stem 126 connects the threaded cap 130 to the body 118. The threaded cap 130 has an internal thread which mates with the threaded end 102 of the helium cylinder 66. The filler valve 110 includes a spike 134 located inside of the threaded cap 130 which pierces the sealed end of the helium canister 66 when the threaded cap 130 is threaded onto the threaded end 102 of the helium canister, as shown in FIG. 10. An internal passage 138 through the filler valve 110 permits fluid flow through the filler valve and a check valve 142 allows fluid flow into the balloon 78 and prevents fluid flow out of the balloon. The filler valve neck 126 may include a groove 146 or other similar structure which allows the cap 130 to be broken away from the body 118 of the filler valve 110.

To deploy the balloon, a person opens the emergence locator beacon 10 at the joint 20 to access the internal components. The balloon 78, filler valve 110, string 106, and spool 82 are removed from the storage compartment 42. The pump piston 62 may be left in the pump cylinder 86 or removed therefrom. The handle 74 is removed from the end 102 of the helium cylinder 66 and the filler valve cap 130 is threaded onto the end 102 of the helium cylinder 66. When the cap 130 is threaded onto the helium canister 66, the internal threads and structure of the cap seals against the end 102 of the helium canister 66. As the cap 130 is fully threaded onto the end 102 of the helium canister 66, the spike 134 pierces the seal over the end of the helium canister. Helium then flows from the canister 66, through an internal passage 138 through the filler valve 110, and into the balloon 78. The check valve 142 prevents the helium from escaping from the balloon 78. If desired, the person may then break the filler valve neck 126 at the preformed breakage point 146 to separate the cap 130 from the filler valve 110 and lighten the balloon 78. The helium balloon 78 may then be deployed; allowing it to float upwardly into the air while remaining tethered to the spool 82 by the line 106. For safety, the line 106 may be tied or bonded to the spool 82 and the spool 82 or line 106 may be tied to the body of the emergency locator beacon 10, a tree, rock, etc. in a position which allows the balloon to float up and alert others to the location of the person desiring assistance. The line 106 may often be between about 50 and 150 feet long to permit the balloon to float above the tree line so that it is easily seen by other people. The balloon 78 is typically a bright color such as orange. A 95 cc helium canister 66 will typically fill a 16 inch balloon 78. Accordingly, the beacon 10 may include a single balloon 78 and a single helium canister 66. If it remains sealed inside of the emergency locator beacon 10 and stored properly, a latex balloon 78 will remain in good condition for a long time.

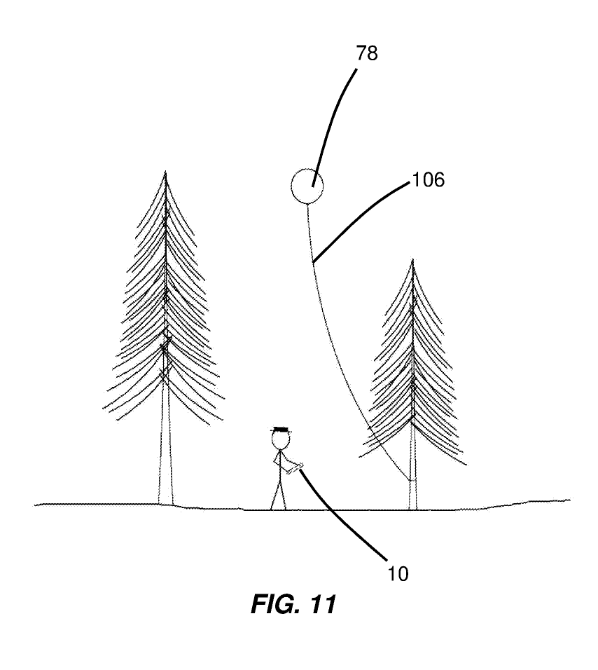

After deploying the balloon, the person may remove the cap 130 from the end 102 of the helium canister 66, secure the handle 74 to the end of the helium canister, and continue to use the air horn 46. This allows a person who is lost or needs assistance to deploy a highly visible balloon which, even outdoors, will typically remain afloat for several days or weeks and operate an air horn without need of any perishable power supply. FIG. 11 shows such a situation where a lost or injured person has deployed and tethered the balloon 78 above surrounding trees and uses the air horn 46 to signal to other persons that they are in need of assistance.

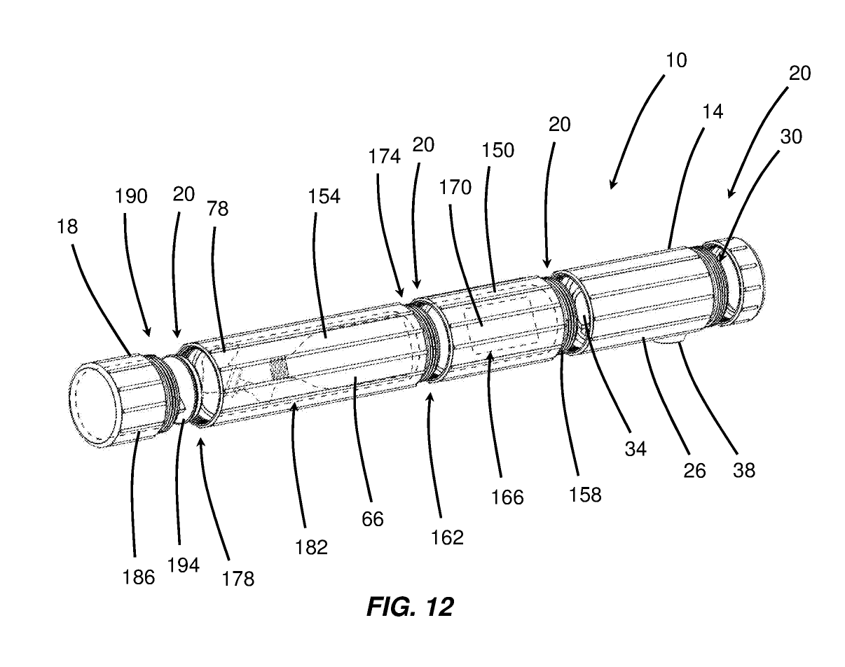

The emergency locator beacon 10 may also store additional components such as a radio beacon inside of the storage compartment 42. Referring now to FIG. 12, another configuration of the emergency locator beacon 10 is shown. FIG. 12 shows a perspective view of an emergency locator beacon 10 which includes multiple configurable compartments. The emergency locator beacon 10 includes a first end 14 and a second end 18. The first end 14 and second end 18 may be separated from each other by multiple joints 20 which attaches the first and seconds end together and which may attach different flashlight body sections 150, 154 (e.g. storage compartment sections 150, 154) between the first and second ends. The different compartment sections 150, 154 may be configured as desired by a user; allowing the user to create a locator beacon with a first compartment section 150, one with a second compartment section 154, or a locator beacon with first and second compartment sections 150, 154. The first end 14 includes a flashlight 22 which may include a flashlight housing 26, a lens and LED light source 30, a battery 34, and a switch 38. The flashlight 22 may be used as a conventional flashlight as well as an emergency beacon. For use as an emergency beacon, the flashlight 22 may flash a distress signal.

The first compartment section 150 has a threaded end 158 which is closed and which attaches to the flashlight housing 26. This may serve to hold the flashlight batteries in place. The first compartment section also has an open end 162 which allows access to an internal storage compartment 166 within the first compartment section 150. The open end 162 may be internally threaded to receive a threaded cap or compartment. The internal storage compartment 166 may be used to store an emergency radio transponder 170 which may broadcast a distress signal at a frequency used by search and rescue units.

The first compartment section 154 has a threaded end 174 which is closed and which attaches to the open end 162 of the first storage compartment 150. This may serve to close the storage compartment 166. The second compartment section 154 also has an open end 178 which allows access to an internal storage compartment 182 within the second compartment section 154. The internal storage compartment 182 may be used to store a helium cylinder 66, balloon 78, spool 82, high volume whistle, etc. The open end 178 may be internally threaded to receive threaded end of a storage compartment or a threaded cap to thereby close the storage compartment 182. The first storage compartment section 150 and the second storage compartment section 154 of the locator beacon 10 may be alternately attached to the flashlight section 22, to each other, and to a rear cap 186 formed by the second end 18 of the beacon 10. This allows a person to customize the locator beacon by attaching one or both storage compartments 150, 154 and selecting which of the emergency locator devices are appropriate for the situation. The rear cap 186 may have an open threaded end 190 that cooperates with a bulkhead 194 which may be received into the end of a storage compartment and which forms a separate smaller storage space in the rear cap.

The emergency locator beacon 10 allows a lost or injured person to remain in a single location while still broadcasting their location to others so that they may obtain assistance. The emergency locator beacon 10 allows a person to deploy a high visibility helium balloon, radio signal, or audible signal to maximize their chances of rescue. The emergency locator beacon 10 remains compact enough (often about 1.5 inches in diameter and 12 inches long) to be carried by a backpacker or hiker without undue inconvenience.

The above description of illustrated examples of the present invention, including what is described in the Abstract, are not intended to be exhaustive or to be limitation to the precise forms disclosed. While specific examples of the invention are described herein for illustrative purposes, various equivalent modifications are possible without departing from the broader scope of the present claims. Indeed, it is appreciated that specific example dimensions, materials, etc., are provided for explanation purposes and that other values may also be employed in other examples in accordance with the teachings of the present invention.

What is claimed is:

1. An emergency flashlight comprising:
a flashlight having a body with a first end and a second end;
a flashlight light source disposed in the first end of the flashlight body, wherein the light source is illuminated during use of the flashlight to project light from the first end of the body;
a joint allowing the body to be separated between the first end and the second end into a first body section having the flashlight light source and a second body section;
an air horn formed as part of the second end of the body and located in the second body section; and
an air pump located in the second body section which is operated to provide air to the air horn.

2. The emergency flashlight of claim 1, wherein the air pump comprises a pump cylinder disposed in the second body section and a manually operated pump piston movable in the pump cylinder.

3. The emergency flashlight of claim 2, wherein the pump piston comprises a helium cylinder and a piston shell attached to the helium cylinder, and wherein the piston shell slides in the pump cylinder to compress air in the pump cylinder.

4. The emergency flashlight of claim 3, further comprising an O-ring located in a groove formed in the piston shell which engages the pump cylinder to seal against the pump cylinder.

5. The emergency flashlight of claim 3, further comprising a pump handle which is attached to a dispensing port of the helium cylinder.

6. The emergency flashlight of claim 5, further comprising a balloon which may be inflated by the helium and a filler valve attached to the balloon, and wherein the pump handle is removed from the dispensing port of the helium cylinder and the filler valve is attached to the helium cylinder dispensing port to fill the balloon with helium.

7. The emergency flashlight of claim 6, wherein the balloon is attached to a spool of line so that the balloon may remain tethered to the flashlight as a visual indicator.

8. The emergency flashlight of claim 5, wherein the balloon is stored in a storage compartment in the flashlight before inflation.

9. An emergency flashlight comprising:
a flashlight having a body with a first end and a second end;
a flashlight battery, switch, and light source disposed in the first end of the flashlight body, wherein the light source is illuminated during use of the flashlight to project light from the first end of the body;
a joint allowing the body to be separated between the first end and the second end into a first body section having the flashlight light source and a second body section;
a first storage compartment body section attachable to the flashlight body between the first body section and the second body section of the flashlight body, the first storage compartment section having an open end and a first storage compartment extending inwardly from the open end; and
a second storage compartment body section attachable to the flashlight body between the first body section and the second body section of the flashlight body and attachable to the first storage compartment body section, the second storage compartment section having an open end and a second storage compartment extending inwardly from the open end.

10. The emergency flashlight of claim 9, wherein the first body section and the second body section may be alternately attached to the emergency flashlight so that the emergency flashlight comprises one of the group consisting of:
the first body section, the first storage compartment body section, and the second body section;
the first body section, the second storage compartment body section, and the second body section; and
the first body section, the first storage compartment body section, the second storage compartment body section, and the second body section.

11. The emergency flashlight of claim 9, wherein the flashlight comprises a helium cylinder, a balloon which may be inflated by the helium cylinder, and a filler valve attached to the balloon disposed in the first storage compartment.

12. The emergency flashlight of claim 11, wherein the flashlight further comprises a spool of line disposed in the first storage compartment and wherein the balloon is attached to the spool of line so that the balloon may remain tethered to the flashlight as a visual indicator after inflation and deployment.

13. The emergency flashlight of claim 9, wherein the flashlight comprises a sound emitting device disposed in the first storage compartment.

14. The emergency flashlight of claim 9, wherein the flashlight comprises:
an air horn formed as part of the second body section; and
an air pump disposed in the second body section which is operated to provide air to the air horn to emit sound therefrom.

15. The emergency flashlight of claim 14, wherein the air pump comprises a pump cylinder disposed in the second body section and a manually operated pump piston movable in the pump cylinder, and wherein the pump piston comprises a helium cylinder and a piston shell attached to the helium cylinder, and wherein the piston shell slides in the pump cylinder to compress air in the pump cylinder.

16. The emergency flashlight of claim 15, wherein the flashlight comprises a balloon which may be inflated by the helium cylinder, a filler valve attached to the balloon, and a spool of line disposed in the first storage compartment and wherein the balloon is attached to the spool of line so that the balloon may remain tethered to the flashlight as a visual indicator after inflation and deployment.

17. An emergency flashlight comprising:
a flashlight having a body with a first end and a second end;
a flashlight battery, switch, and light source disposed in the first end of the flashlight body, wherein the light source is illuminated during use of the flashlight to project light from the first end of the body;
a joint allowing the body to be separated between the first end and the second end into a first body section having the flashlight light source and a second body section;
a first storage compartment located within the flashlight body; and
a helium cylinder, a balloon which may be inflated by the helium cylinder, and a spool of line disposed in the first storage compartment and wherein the balloon is attached to the spool of line so that the balloon may remain tethered to the flashlight as a visual indicator after inflation and deployment.

18. The emergency flashlight of claim 17, wherein the flashlight comprises:
an air horn formed as part of the second body section; and
an air pump disposed in the second body section which is operated to provide air to the air horn to emit sound therefrom.

19. The emergency flashlight of claim 18, wherein the air pump comprises a pump cylinder disposed in the second body section and a manually operated pump piston movable in the pump cylinder, and wherein the pump piston comprises a helium cylinder and a piston shell attached to the helium cylinder, and wherein the piston shell slides in the pump cylinder to compress air in the pump cylinder.
